(19) United States
(12) Patent Application Publication
(10) Pub. No.: US 2007/0183784 A1
(43) Pub. Date: Aug. 9, 2007

(54) Multichannel bidirectional optical transceiver

(75) Inventors: Gyu-Woong Lee, Suwon-si (KR); Chang-Sup Shim, Seoul (KR); Yun-Je Oh, Yongin-si (KR); Seong-Taek Hwang, Pyeongtaek-si (KR); Byung-Jik Kim, Seongnam-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/581,241

(22) Filed: Oct. 16, 2006

(30) Foreign Application Priority Data
Feb. 7, 2006 (KR) 2006-11673

(51) Int. Cl. H04B 10/00

(52) U.S. Cl. 398/135

(57) ABSTRACT

A multichannel bidirectional optical transceiver is disclosed. The transceiver includes an optical fiber transmitting downstream optical signals and receiving upstream optical signals, a plurality of vertical surface light-emitting sources that generate the downstream optical signals and a plurality of vertical surface light-receiving detectors that receive the upstream optical signals. The transceiver also includes an optical coupler that outputs the downstream optical signals and the upstream optical signals received through the optical fiber to the optical fiber and the vertical surface light-receiving detectors, respectively.

### CLAIM OF PRIORITY

This application claims priority to an application entitled “MULTICHANNEL BIDIRECTIONAL OPTICAL TRANSCEIVER,” filed in the Korean Intellectual Property Office on Feb. 7, 2006 and assigned Serial No. 2006-0011673, the contents of which are hereby incorporated by reference.

### BACKGROUND OF THE INVENTION

1. Field of the Invention

The present invention relates to a bidirectional optical transceiver, and more particularly to a multichannel bidirectional optical transceiver having a plurality of vertical surface light-emitting or receiving optical devices.

2. Description of the Related Art

A typical surface light-emitting laser includes an InP substrate, a lower mirror formed on the substrate, an active layer subjected to multilayer growth of an InP based InGaAs/InGaAsP material on the lower mirror, and an upper mirror formed on the active layer. Either the lower or upper mirrors requires an ideal reflectance ratio of 1, and the other mirror requires at least a reflectance ratio of 0.95. Both of the lower and upper mirrors may include a Bragg grating having a super lattice thin film structure.

A multichannel bidirectional optical transceiver using the surface light-emitting laser or a surface light-receiving detector is disclosed in U.S. Patent Published Application No. 2004/0042736, granted to Capwell, et al., and titled Multi-wavelength Transceiver Device with Integration on Transistor-outline Cans. The device of Capwell, et al. includes a structure having a separate reflective layer and a plurality of end face light-emitting lasers in order to transmit optical signals. The data is carried on a plurality of channels each having different wavelengths.

However, such conventional optical transceiver has shortcomings in that bidirectional transmission and reception are impossible and when being fabricated alignment of such devices is complicated.

### SUMMARY OF THE INVENTION

Accordingly, one aspect of the present invention is to solve the above-mentioned problems occurring in the prior art.

One objective of the present invention is to provide a multichannel bidirectional optical transceiver allowing easy fabrication and bidirectional transmission/reception.

According to one embodiment of the present invention, a multichannel bidirectional optical transceiver is disclosed. The transceiver includes an optical fiber that transmits downstream optical signals and receives upstream optical signals, a plurality of vertical surface light-emitting sources that generate the downstream optical signals, a plurality of vertical surface light-receiving detectors that receive the upstream optical signals, an optical coupler that outputs the downstream optical signals and the upstream optical signals received through the optical fiber to the optical fiber and the vertical surface light-receiving detectors, respectively.

### BRIEF DESCRIPTION OF THE DRAWINGS

The above features and embodiments of the present invention will be more apparent from the following detailed description taken in conjunction with the accompanying drawing, in which:

FIG. 1 illustrates a multichannel bidirectional optical transceiver according to an exemplary embodiment of the present invention.

### DETAILED DESCRIPTION OF THE INVENTION

Hereinafter, exemplary embodiments of the present invention will be described with reference to the accompanying drawings. For the purposes of clarity and simplicity, a detailed description of known functions and configurations incorporated herein will be omitted as it may obscure the subject matter of the present invention.

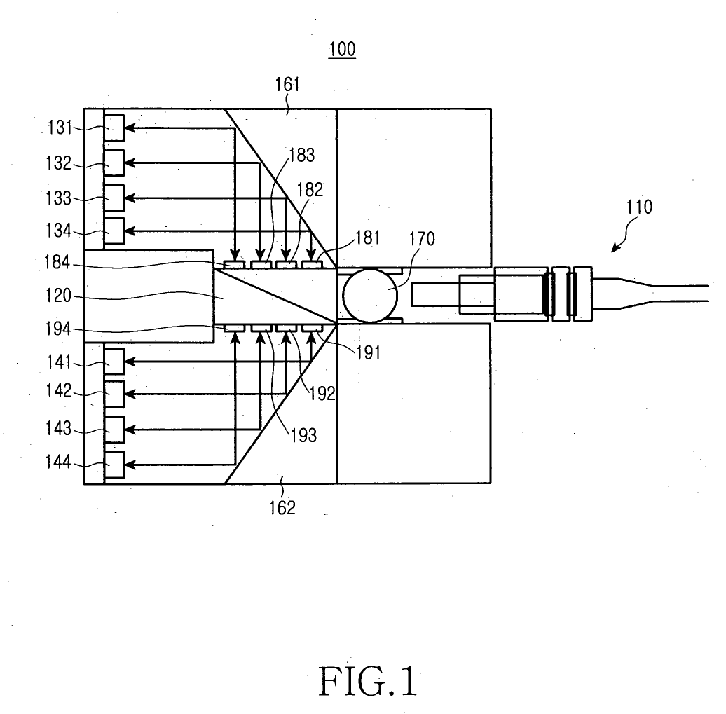

FIG. 1 illustrates a multichannel bidirectional optical transceiver 100 according to one embodiment of the present invention. The bidirectional optical transceiver 100 includes an optical fiber 110 that transmits downstream optical signals and receives upstream optical signals, a plurality of vertical surface light-emitting sources 131, 132, 133 and 134 that generate the downstream optical signals, a plurality of vertical surface light-receiving detectors 141, 142, 143 and 144 that receive the upstream optical signals, an optical coupler 120, first and second reflectors 161 and 162, first and second band pass filters 181, 182, 183 and 184; and 191, 192, 193 and 194, and a lens system 170.

The optical fiber 110 may be coupled to the multichannel bidirectional optical transceiver 100 by a connection terminal (not shown in FIG. 1).

The plurality of vertical surface light-emitting sources 131, 132, 133 and 134 may be, for example, a Vertical-Cavity Surface-Emitting Laser (VCSEL). A VCSEL is a type of semiconductor laser diode with laser beam emission perpendicular from the top surface, contrary to conventional edge-emitting semiconductor lasers (also in-plane lasers) which emit from surfaces formed by cleaving the individual chip out of a wafer. Because VCSELs emit from the top surface of the chip, they can be tested on-wafer, before they are cleaved into individual devices. This reduces the fabrication cost of the devices. It also allows VCSELs to be built not only in one-dimensional, but also in two-dimensional arrays.

The bidirectional optical transceiver 100 has a multichannel mode that uses the plurality of vertical surface light-emitting sources 131 to 134, and the plurality of vertical surface light-receiving detectors 141 to 144. Typically, the downstream and upstream optical signals can make use of different wavelength bands. For example, the downstream optical signals may use a wavelength band of 1300 nm, and the upstream optical signals may use a wavelength band of 800 nm.

The vertical surface light-emitting sources 131 to 134 generate the downstream optical signals having different wavelengths. The first band pass filters 181 to 184 allow only the downstream optical signals having the corresponding wavelengths to be transmitted to the optical coupler 120. The vertical surface light-receiving detectors 141 to 144 can detect the upstream optical signals having the corresponding wavelengths which pass through the second band pass filters 191 to 194.

The optical coupler 120 outputs the downstream optical signals reflected on the first reflector 161 and the upstream optical signals input through the lens system 170 to the optical fiber 110 and the second reflector 162, respectively. In this embodiment, the optical coupler 120 is located between the first and second reflectors 161 and 162. The second reflector 162 reflects the upstream optical signals onto the vertical surface light-receiving detectors 141 to 144.

The first band pass filters 181 to 184 may be located on one surface of the optical coupler 120 which is opposite to the first reflector 161, while the second band pass filters 191 to 194 may be located on the other surface of the optical coupler 120 which is opposite to the second reflector 162.

The first band pass filters 181 to 184 allow the corresponding downstream optical signals generated from the vertical surface light-emitting sources 131 to 134 to be transmitted to the optical coupler 120. Some of the upstream optical signals are also reflected and introduced into the optical coupler 120 onto the second band pass filters 191 to 194. The second band pass filters 191 to 194 allow the upstream optical signals input from the optical coupler 120 to be transmitted to the second reflector 162. In this way, the first and second band pass filters 181 to 184 and 191 to 194 serve to select wavelengths.

The lens system 170 converges the downstream optical signals and the upstream optical signals input through the optical fiber 110 on the optical fiber 110 and the optical coupler 120, respectively. In this embodiment, the lens system 170 is located between the optical fiber 110 and the optical coupler 120. The optical fiber 110 may be in the form of a ferrule to bidirectionally transceive the downstream and upstream optical signals.

The structure of this embodiment can realize the multichannel bidirectional optical transceiver that allows for easy optical axis alignment and bidirectional transmission and reception.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A multichannel bidirectional optical transceiver, comprising:
an optical fiber that transmits downstream optical signals and receives upstream optical signals;
a plurality of vertical surface light-emitting sources that generate the downstream optical signals;
a plurality of vertical surface light-receiving detectors that receive the upstream optical signals; and
an optical coupler that outputs the downstream optical signals and the upstream optical signals received through the optical fiber to the optical fiber and the vertical surface light-receiving detectors, respectively.

2. The multichannel bidirectional optical transceiver according to claim 1, further comprising:
a first reflector that is located between the optical coupler and the vertical surface light-emitting sources and reflects the downstream optical signals generated from the vertical surface light-emitting sources onto the optical coupler; and
a second reflector that is located between the optical coupler and the vertical surface light-receiving detectors and reflects the upstream optical signals output from the optical coupler onto the vertical surface light-emitting sources.

3. The multichannel bidirectional optical transceiver according to claim 2, further comprising:
a plurality of first band pass filters that are located on one surface of the optical coupler opposite to the first reflector and allow the downstream optical signals to be transmitted to the optical coupler; and
a plurality of second band pass filters that are located on the other surface of the optical coupler opposite to the second reflector and allow the upstream optical signals to be transmitted from the optical coupler to the second reflector.

4. The multichannel bidirectional optical transceiver according to claim 1, further comprising a lens system that is located between the optical fiber and the optical coupler and converges the downstream optical signals and the upstream optical signals input through the optical fiber on the optical fiber and the optical coupler, respectively.

5. A multichannel bidirectional optical transceiver, comprising:
a connection terminal for an optical fiber that transmits downstream optical signals and receives upstream optical signals;
a first array of vertical surface light-emitting sources arranged to generate the downstream optical signals;
a second array of vertical surface light-receiving detectors arranged to receive the upstream optical signals; and
an optical coupler arranged to output the downstream optical signals from the first array and output the upstream optical signals input through the connection terminal and the second array, respectively.

6. The multichannel bidirectional optical transceiver according to claim 5, further comprising:
a first reflector arranged to reflect the downstream optical signals generated from the first array onto the optical coupler; and
a second reflector arranged to reflect the upstream optical signals output from the optical coupler onto the second array.

7. The multichannel bidirectional optical transceiver according to claim 6, further comprising:
a plurality of first band pass filters arranged to allow wavelengths of the downstream optical signals to be transmitted to the optical coupler; and
a plurality of second band pass filters arranged to allow wavelengths of the upstream optical signals to be transmitted from the optical coupler to the second reflector.

8. The multichannel bidirectional optical transceiver according to claim 5, further comprising a lens system that is located between the connection terminal and the optical coupler.

9. The multichannel bidirectional optical transceiver according to claim 5, wherein the first array is a two-dimensional array.

10. The multichannel bidirectional optical transceiver according to claim 5, wherein the second array is a two-dimensional array.

11. The multichannel bidirectional optical transceiver according to claim 5, wherein the first and the second arrays are two-dimensional array.
